(19) United States
(12) Patent Application Publication
(10) Pub. No.: US 2024/0308357 A1
(43) Pub. Date: Sep. 19, 2024

(54) COIL UNIT

(71) Applicant: HONDA MOTOR CO., LTD., Tokyo (JP)

(72) Inventor: Jin Katsuya, Wako-shi (JP)

(21) Appl. No.: 18/581,421

(22) Filed: Feb. 20, 2024

(30) Foreign Application Priority Data
Mar. 16, 2023 (JP) 2023-041580

(51) Int. Cl. B60L 53/122; H02J 50/00; H02J 50/12

(52) U.S. Cl. CPC B60L 53/122; H02J 50/005; H02J 50/12; B60L 2270/147

(57) ABSTRACT

A coil unit includes: an electric power reception portion of an electric power reception device mounted on a vehicle; and a control device. The electric power reception portion includes a secondary side coil and a secondary side capacitor that are connected in series. The secondary side coil receives an AC electric power transmitted in a contactless manner from the electric power transmission device. When receiving the AC electric power transmitted in a contactless manner from a primary side coil of the electric power transmission device, the secondary side coil that generates a reverse-phase current with respect to the primary side coil. A capacitance of the secondary side capacitor is set in accordance with a resonance point on a high frequency side of two resonance points in accordance with the secondary side coil and the secondary side capacitor.

### CROSS-REFERENCE TO RELATED APPLICATION

Priority is claimed on Japanese Patent Application No. 2023-041580, filed on Mar. 16, 2023, the contents of which are incorporated herein by reference.

### BACKGROUND

### Field of the Invention

The present invention relates to a coil unit.

### Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted.

In the related art, in a contactless electric power transmission system that supplies electric power to a vehicle from the outside of the vehicle by contactless electric power transmission, a configuration is known which reduces a leakage magnetic flux (that is, a magnetic flux other than a main magnetic flux that interlinks an electric power transmission-side coil and an electric power reception-side coil) with respect to an electric power transmission-side coil at the outside of the vehicle and an electric power reception-side coil of the vehicle (for example, refer to Japanese Unexamined Patent Application, First Publication No. 2011-234496 and Japanese Unexamined Patent Application, First Publication No. 2014-193013).

### SUMMARY

In techniques relating to charging and electric power supply in a vehicle on which a secondary battery is mounted, it is desired to improve an output and an efficiency of the charging and electric power supply. For example, in the contactless electric power transmission system of the related art described above, it is desired to improve a coupling coefficient by increasing an output density and preventing occurrence of unwanted radiation without requiring a change in a vehicle shape of lowering a ground height or the like.

An aspect of the present invention aims to provide a coil unit that can improve a coupling coefficient by increasing an output density and reducing unwanted radiation in contactless electric power transmission. Further, the aspect of the present invention contributes to energy efficiency.

A coil unit according to a first aspect of the present invention includes: a coil that generates, when receiving an AC electric power transmitted in a contactless manner from an electric power transmission-side coil of an electric power transmission device, a reverse-phase current with respect to the electric power transmission-side coil.

A second aspect is the coil unit according to the first aspect described above, wherein in a state of looking from a predetermined identical direction, a wind direction of the coil may be set in an opposite direction with respect to a wind direction of the electric power transmission-side coil.

A third aspect is the coil unit according to the first or second aspect described above which may include: a resonant capacitor connected in series to the coil, wherein a capacitance of the capacitor may be set in accordance with a resonance point on a high frequency side of two resonance points in accordance with the coil and the capacitor.

A fourth aspect is the coil unit according to the third aspect described above which may include: a control device that sets a frequency corresponding to the resonance point on the high frequency side to a request frequency of electric power transmission by the electric power transmission device.

According to the first aspect described above, by including the coil that generates a reverse-phase current with respect to the electric power transmission-side coil, phases by a magnetic field coupling and an electric field coupling can be displaced from each other, and it is possible to prevent a magnetic field coupling coefficient and an electric field coupling coefficient from annihilating each other. By preventing the coupling coefficient by the electric field coupling from reducing, it is possible to improve an output density.

For example, compared to the case of including a coil that generates an in-phase current with respect to the electric power transmission-side coil, it is possible to prevent the decrease of the coupling coefficient associated with the increase of a gap between the electric power transmission-side coil and the coil, and the coupling coefficient can be improved. Further, it is possible to prevent the increase of a magnetic flux density around the electric power transmission-side coil and the coil due to unwanted radiation.

In the case of the second aspect described above, it is possible to easily provide the coil that generates a reverse-phase current with respect to the electric power transmission-side coil.

In the case of the third aspect described above, for example, compared to the case where the capacitance of the capacitor is set in accordance with an anti-resonance point, it is possible to prevent generation of a leakage magnetic flux that interferes with the main magnetic flux and prevent reduction of a magnetic flux transmitted to the coil. By preventing the decrease of the coupling coefficient by the leakage magnetic flux, the output density can be improved.

In the case of the fourth aspect described above, by increasing the output density and reducing the unwanted radiation in the contactless electric power transmission, the coupling coefficient can be improved.

### BRIEF DESCRIPTION OF THE DRAWINGS

FIG. 1 is a view showing a configuration of a contactless electric power transmission system including a coil unit of an embodiment of the present invention.

FIG. 2 is a view showing a configuration of an electric power transmission portion and an electric power reception portion of the contactless electric power transmission system in the embodiment of the present invention.

FIG. 3 is a perspective view showing a primary side coil of an electric power transmission device and a secondary side coil of an electric power reception device in the embodiment of the present invention.

FIG. 4 is a graph view showing an example of a correspondence relationship between an impedance and a frequency in the coil unit of the embodiment of the present invention.

FIG. 5 is a graph view showing an actual measurement example of a correspondence relationship among an impedance, a phase, and a frequency in the coil unit of the embodiment of the present invention.

FIG. 6 is a view showing an example of a magnetic flux density distribution in each of the coil unit of the embodiment of the present invention and a first comparison example.

FIG. 7 is a graph view showing an example of a correspondence relationship between a coupling coefficient k and a gap between the primary side coil and the secondary side coil in each of the coil unit of the embodiment of the present invention and a second comparison example.

FIG. 8 is a view showing an example of a flux density distribution in each of the coil unit of the embodiment of the present invention and a second comparison example.

### DESCRIPTION OF EMBODIMENTS

Hereinafter, a coil unit according to an embodiment of the present invention will be described with reference to the drawings.

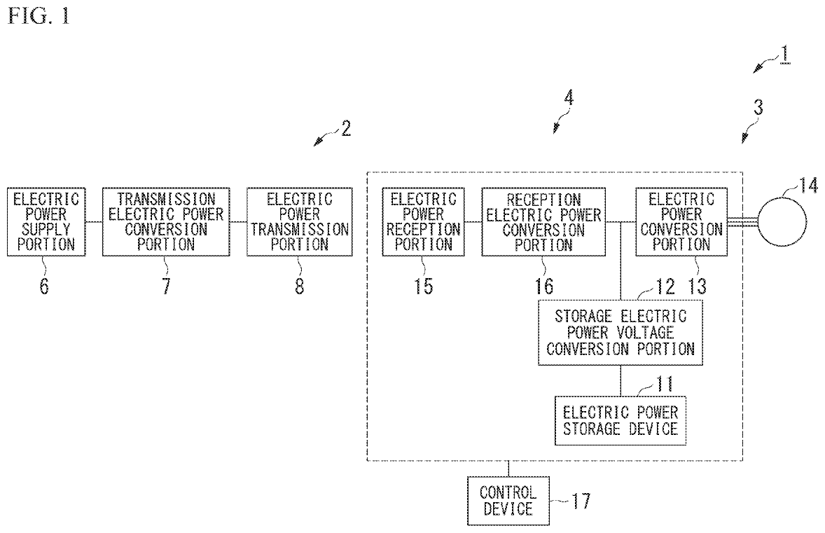

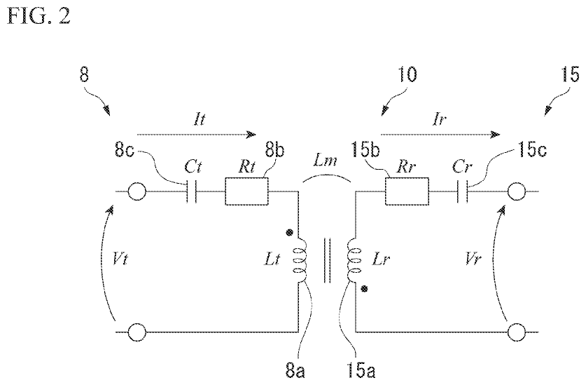

FIG. 1 is a view showing a configuration of a contactless electric power transmission system 1 including a coil unit 10 of an embodiment. FIG. 2 is a view showing a configuration of an electric power transmission portion 8 and an electric power reception portion 15 of the contactless electric power transmission system 1 in the embodiment.

The coil unit 10 of the embodiment constitutes, for example, part of the contactless electric power transmission system 1 that supplies electric power from the outside of a movable body such as a vehicle to the movable body by contactless power transmission. The coil unit 10 of the embodiment is mounted, for example, on a movable body such as a vehicle. The vehicle includes, for example, electric vehicles such as electric automobiles, hybrid vehicles, and fuel cell vehicles.

### (Contactless Electric Power Transmission System)

As shown in FIG. 1, the contactless electric power transmission system 1 of the embodiment includes: for example, an electric power transmission device 2 provided on a travel path or the like of a vehicle; and a drive control device 3 and an electric power reception device 4 that are mounted on the vehicle.

The electric power transmission device 2 includes, for example, an electric power supply portion 6, a transmission electric power conversion portion 7, and the electric power transmission portion 8. The electric power transmission device 2 may include, for example, at least a plurality of electric power transmission portions 8 in a predetermined electric power transmission zone on the travel path of the vehicle.

The electric power supply portion 6 includes, for example, an AC power source such as a commercial power source, an AC-DC converter that converts AC electric power into DC electric power, and an electric power smoothing capacitor. The electric power supply portion 6 converts AC electric power supplied from the AC power source into DC electric power by the AC-DC converter.

The transmission electric power conversion portion 7 includes, for example, an inverter that converts DC electric power into AC electric power. The inverter of the transmission electric power conversion portion 7 includes: for example, a bridge circuit formed of a plurality of switching elements connected in two phases by bridge connection and a rectifier element; and a voltage smoothing capacitor. Each switching element is, for example, a transistor such as a SiC (Silicon Carbide) MOSFET (Metal Oxide Semi-conductor Field Effect Transistor). The plurality of switching elements are high-side arm and low-side arm transistors that form a pair in each phase. The rectifier element is, for example, a reflux diode connected in parallel with each transistor. The voltage smoothing capacitor is connected in parallel with the bridge circuit.

The electric power transmission portion 8 transmits electric power by a change of a high frequency magnetic field, for example, by magnetic field coupling such as magnetic field resonance or electromagnetic induction. As shown in FIG. 2, the electric power transmission portion 8 includes, for example, a resonance circuit formed of a primary side coil 8a (electric power transmission-side coil), a primary side resistance 8b, and a primary side capacitor 8c that are connected in series. The electric power transmission portion 8 includes, for example, a sensor such as a current sensor that detects a current It flowing through the resonance circuit.

For example, the electric power transmission device 2 performs electric power transmission to the electric power reception device 4 of the vehicle by controlling the switching between ON (conduction) and OFF (cutoff) of each switching element of the transmission electric power conversion portion 7 in accordance with information of a drive frequency set in advance or a desired frequency received from the electric power reception device 4.

As shown in FIG. 1, the drive control device 3 of the vehicle includes, for example, an electric power storage device 11, a storage electric power voltage conversion portion 12, an electric power conversion portion 13, and a rotary electric machine 14. The electric power reception device 4 of the vehicle includes, for example, an electric power reception portion 15 and a reception electric power conversion portion 16. The drive control device 3 and the electric power reception device 4 include, for example, a common control device 17.

For example, in the case of an electric automobile or the like that is driven using the electric power storage device 11 as a power source, the drive control device 3 may not include the storage electric power voltage conversion portion 12. For example, in the case of a hybrid vehicle or the like that is driven using the electric power storage device 11 and an internal combustion engine as a power source, the drive control device 3 may include the storage electric power voltage conversion portion 12.

The electric power storage device 11 is connected to the storage electric power voltage conversion portion 12. The electric power storage device 11 is charged by electric power transmitted in a contactless manner from the electric power transmission device 2 at the outside of the vehicle. The electric power storage device 11 transmits and receives electric power between the electric power storage device 11 and the rotary electric machine 14 via the storage electric power voltage conversion portion 12 and the electric power conversion portion 13.

The electric power storage device 11 includes, for example, a battery such as a lithium-ion battery, a current sensor that detects a current of the battery, and a voltage sensor that detects a voltage of the battery.

For example, when the storage electric power voltage conversion portion 12 is not provided in an electric automobile or the like, the electric power storage device 11 is connected to the electric power conversion portion 13 and the reception electric power conversion portion 16 described later.

The storage electric power voltage conversion portion 12 is connected to the electric power conversion portion 13 and the reception electric power conversion portion 16. The storage electric power voltage conversion portion 12 includes, for example, a voltage controller that performs voltage conversions in both voltage-increase and voltage-decrease directions.

The voltage controller converts input electric power and output electric power at the time of charging and discharging of the electric power storage device 11 by the bi-directional voltage conversion. The voltage controller of the storage electric power voltage conversion portion 12 includes, for example, a pair of first reactors, a first element module, and a voltage smoothing capacitor.

The pair of first reactors are magnetically coupled to each other at opposite polarity and thereby form a composite reactor. The pair of first reactors are connected to a connection point between a high side arm and a low side arm of each phase of the first element module.

The first element module includes, for example, a first bridge circuit formed of a plurality of switching elements connected in two phases by bridge connection and a rectifier element. Each switching element is, for example, a transistor such as a SiC MOSFET. The plurality of switching elements are high-side arm and low-side arm transistors that form a pair in each phase. The rectifier element is, for example, a reflux diode connected in parallel with each transistor. The voltage smoothing capacitor is connected in parallel with the electric power storage device 11.

The storage electric power voltage conversion portion 12 includes a resistance and a transistor that are connected in series. The resistance and the transistor are connected in parallel with the first bridge circuit.

The pair of first reactors and the first element module of the voltage controller perform voltage conversion by so-called two-phase interleaving. In the two-phase interleaving, one cycle of a switching control of a first-phase transistor of two-phase transistors connected to the pair of first reactors and one cycle of a switching control of a second-phase transistor are displaced from each other by half a cycle.

The electric power conversion portion 13 is connected to the rotary electric machine 14. The electric power conversion portion 13 includes, for example, an electric power converter that performs conversion between DC electric power and AC electric power. The electric power converter includes, for example, a second element module and a voltage smoothing capacitor.

The second element module includes, for example, a second bridge circuit formed of a plurality of switching elements connected in three phases by bridge connection and a rectifier element. Each switching element is, for example, a transistor such as a SiC MOSFET. The plurality of switching elements are high-side arm and low-side arm transistors that form a pair in each phase. The rectifier element is, for example, a reflux diode connected in parallel with each transistor. The voltage smoothing capacitor is connected in parallel with the second bridge circuit.

The second element module controls an operation of the rotary electric machine 14 by transmission and reception of electric power. For example, at the time of power running of the rotary electric machine 14, the second element module converts DC electric power input from DC terminals of a positive electrode and a negative electrode into three-phase AC electric power and supplies the three-phase AC electric power from a three-phase AC terminal to the rotary electric machine 14. The second element module generates a rotation drive force by sequentially commutating electric power supply to a three-phase stator winding of the rotary electric machine 14.

For example, at the time of regeneration of the rotary electric machine 14, the second element module converts the three-phase AC electric power input from the three-phase stator winding into DC electric power by the driving between ON (conduction) and OFF (cutoff) of the switching element of each phase synchronized with the rotation of the rotary electric machine 14. The second element module can supply the DC electric power converted from the three-phase AC electric power to the electric power storage device 11 via the storage electric power voltage conversion portion 12.

The rotary electric machine 14 is, for example, a three-phase AC brushless DC motor provided for traveling and driving of the vehicle. The rotary electric machine 14 includes a rotor having a field permanent magnet and a stator having a three-phase stator winding that generates a rotation magnetic field which rotates the rotor. The three-phase stator winding is connected to a three-phase AC terminal of the electric power conversion portion 13.

The rotary electric machine 14 performs a power running operation using electric power supplied from the electric power conversion portion 13 and thereby generates a rotation drive force. For example, when the rotary electric machine 14 is connectable to a wheel of the vehicle, the rotary electric machine 14 performs the power running operation using electric power supplied from the electric power conversion portion 13 and thereby generates a travel drive force. The rotary electric machine 14 may perform a regeneration operation using a rotation power input from the wheel side of the vehicle and thereby generate electric power. When the rotary electric machine 14 is connectable to the internal combustion engine of the vehicle, the rotary electric machine 14 may generate electric power using the power of the internal combustion engine.

The electric power reception portion 15 is connected to the reception electric power conversion portion 16. The electric power reception portion 15 receives electric power by a change of a high frequency magnetic field transmitted from the electric power transmission portion 8, for example, by magnetic field coupling such as magnetic field resonance or electromagnetic induction. As shown in FIG. 2, the electric power reception portion 15 includes, for example, a resonance circuit formed of a secondary side coil 15a (coil), a secondary side resistance 15b, and a secondary side capacitor 15c (capacitor) that are connected in series. The electric power reception portion 15 includes, for example, a sensor such as a current sensor that detects a current Ir flowing through the resonance circuit.

The reception electric power conversion portion 16 shown in FIG. 1 is connected to the electric power conversion portion 13. The reception electric power conversion portion 16 includes a so-called full-bridgeless (or bridgeless and totem-pole) power factor correction (PFC) circuit that converts AC electric power into DC electric power. The so-called bridgeless PFC is a PFC that does not include a bridge rectifier using a plurality of diodes connected by bridge connection. The so-called totem-pole PFC is a PFC that includes a pair of switching elements having the same conductivity type connected (totem-pole connection) in series in the same direction.

The reception electric power conversion portion 16 includes: for example, a third bridge circuit formed of a plurality of switching elements connected in two phases by bridge connection and a rectifier element; and a voltage smoothing capacitor. Each switching element is, for example, a transistor such as a SiC MOSFET. The plurality of switching elements are high-side arm and low-side arm transistors that form a pair in each phase. The rectifier element is, for example, a reflux diode connected in parallel with each transistor. The voltage smoothing capacitor is connected in parallel with the third bridge circuit.

For example, the electric power reception device 4 including the electric power reception portion 15 and the reception electric power conversion portion 16 receives electric power transmitted from the electric power transmission device 2 by controlling the switching between ON (conduction) and OFF (cutoff) of each switching element of the reception electric power conversion portion 16 in accordance with information of a frequency of electric power transmission by the electric power transmission device 2.

The control device 17 integrally controls, for example, the drive control device 3 and the electric power reception device 4 of the vehicle.

The control device 17 is, for example, a software function unit that functions by a predetermined program being executed by a processor such as a CPU (Central Processing Unit). The software function unit is an ECU that includes a processor such as a CPU, a ROM (Read Only Memory) that stores a program, a RAM (Random Access Memory) that temporarily stores data, and an electronic circuit such as a timer. At least part of the control device 17 may be an integrated circuit such as a LSI (Large Scale Integration).

For example, the control device 17 generates a control signal indicating a timing of driving each switching element to ON (conduction) and OFF (cutoff) and generates a gate signal for actually driving each switching element to ON and OFF on the basis of the control signal.

For example, by controlling the switching of each switching element of the electric power reception device 4, the control device 17 performs the power factor correction of the input voltage and the input current while rectifying the AC electric power received from the electric power transmission device 2 to DC electric power.

For example, the control device 17 controls an output in accordance with a target output by a synchronous rectification operation that synchronously drives the plurality of switching elements of the electric power reception device 4 to ON and OFF and a short circuit operation that shorts the secondary side coil 15a.

For example, the control device 17 controls the synchronous rectification operation in accordance with the magnitude and the phase of a current generated in the electric power reception portion 15 by the electric power transmitted from the electric power transmission device 2, that is, the current Ir flowing through the secondary side coil 15a. The control device 17 controls the plurality of switching elements of the reception electric power conversion portion 16 by soft switching of so-called zero voltage switching (ZVS). In the zero voltage switching (ZVS), in each switching element, after a voltage of both ends is set to zero by the discharge of an output capacitance (parasitic capacitance) in an OFF state in a dead time period of each phase, turn-on (switching from an OFF state to an ON state) is performed.

For example, the control device 17 controls the short circuit operation by only turning on the low side arm of each phase while continuing the synchronous rectification operation of the zero voltage switching (ZVS) at the high side arm of each phase of the reception electric power conversion portion 16.

For example, the control device 17 sets a frequency (request frequency) required for electric power transmission by the electric power transmission device 2 on the basis of a minimum ground height of the vehicle and a mounting layout of the electric power reception device 4 in the vehicle which are related to a distance between the primary side coil 8a and the secondary side coil 15a, a state of electric power transmission between the electric power transmission device 2 and the electric power reception device 4, a desired efficiency and output (electric power) of electric power transmission, or the like.

The control device 17 transmits the request frequency to the electric power transmission device 2 by an appropriate communication between the electric power transmission device 2 and the vehicle. The communication between the electric power transmission device 2 and the vehicle is, for example, a communication by an inductor voltage between the coils 8a, 15a of the electric power transmission device 2 and the electric power reception device 4, a wireless communication by a communication device additionally provided on each of the electric power transmission device 2 and the vehicle, or the like.

The coil unit 10 of the embodiment includes, for example, the electric power reception portion 15 of the electric power reception device 4 mounted on the vehicle and the control device 17.

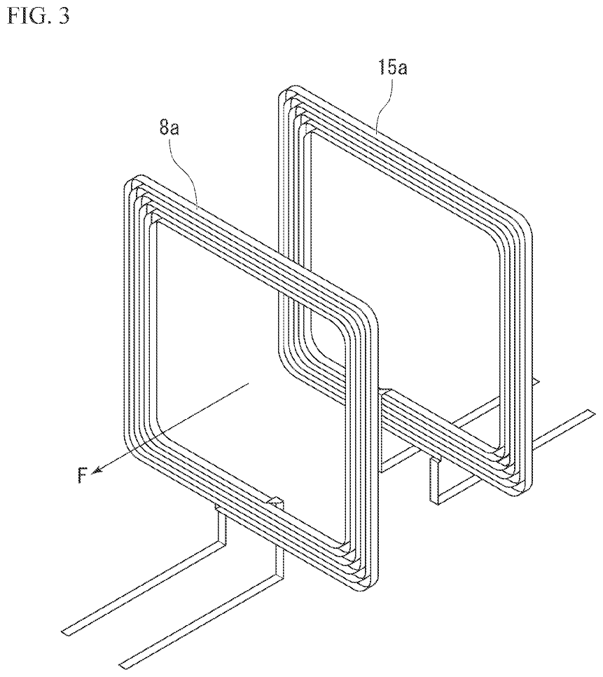

FIG. 3 is a perspective view showing the primary side coil 8a of the electric power transmission device 2 and the secondary side coil 15a of the electric power reception device 4 in the embodiment.

As shown in FIG. 3, in a state of looking from a predetermined identical direction F, a wind direction of the secondary side coil 15a of the electric power reception device 4 is set in an opposite direction with respect to a wind direction of the primary side coil 8a of the electric power transmission device 2. The predetermined identical direction F is, for example, a direction in which the primary side coil 8a and the secondary side coil 15a face each other or the like. That is, the primary side coil 8a of the electric power transmission device 2 and the secondary side coil 15a of the electric power reception device 4 are provided so as to generate a reverse-phase current with each other at the time of electric power transmission.

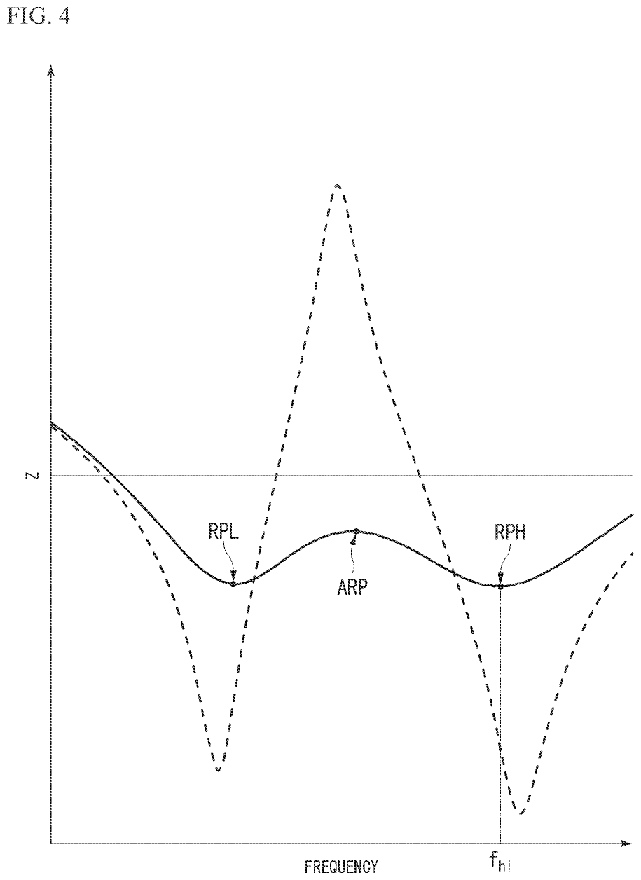

FIG. 4 is a graph view showing an example of a correspondence relationship between an impedance Z and a frequency in the coil unit 10 of the embodiment. The solid line shown in FIG. 4 indicates the case where there is an optimum load resistance that maximizes the efficiency of electric power transmission, and the dashed line represents the case where there is not a load resistance.

As shown in FIG. 4, the frequency characteristic of the impedance Z in the coil unit 10 of the embodiment has two resonance points in accordance with the resonance circuit formed of the secondary side coil 15a, the secondary side resistance 15b, and the secondary side capacitor 15c that are connected in series of the electric power reception device 4. A resonance point RPL at which the impedance Z is locally minimized at a low-frequency side represents an in-phase resonance mode, and a resonance point RPH at which the impedance Z is locally minimized at a high-frequency side represents a reverse-phase resonance mode. An anti-resonance point ARP at which the impedance Z is locally maximized between the two resonance points RPL, RPH represents a point of switching between the in-phase resonance mode and the reverse-phase resonance mode.

The capacitance of the secondary side capacitor 15c in the coil unit 10 is set such that, for example, a frequency (frequency of a high frequency mode) fₕᵢ corresponding to the resonance point RPH at the high frequency side in a predetermined normal temperature state becomes a request frequency of the electric power transmission device 2.

For example, as shown in Expression (1) described below, the frequency fₕᵢ of the high frequency mode and a characteristic frequency f₀ of each of the primary side coil 8a and the secondary side coil 15a are described by a coupling coefficient k between the primary side coil 8a and the secondary side coil 15a. The characteristic frequency f₀ is set to, for example, a predetermined frequency such as 85 kH.

$$[ Expression 1 ]$$

$${f}_{0} = {f}_{hi} \sqrt{( 1 - k )} \qquad ( 1 )$$

Based on Expression (1) described above, in order to match the resonance point with the frequency fₕᵢ of the high frequency mode, a capacitance C1 of the primary side capacitor 8c and a capacitance C2 of the secondary side capacitor 15c are set as shown in Expression (2) described below. In Expression (2) described below, the capacitances C1, C2 are described by the frequency fₕᵢ of the high frequency mode, a self-inductance L₁ of the primary side coil 8a, a self-inductance L₂ of the secondary side coil 15a, and the coupling coefficient k between the primary side coil 8a and the secondary side coil 15a.

The control device 17 sets the frequency fₕᵢ corresponding to the resonance point RPH at the high frequency side of the two resonance points RPL, RPH in the frequency characteristic of the impedance Z to the request frequency with respect to electric power transmission by the electric power transmission device 2.

$$[ Expression 2 ]$$

$$\begin{matrix}C 1 = \frac{1}{4 {π}^{2} {f}_{hi}^{2} ( 1 - k ) {L}_{1}} \\ C 2 = \frac{1}{4 {π}^{2} {f}_{hi}^{2} ( 1 - k ) {L}_{2}}\end{matrix} \} \qquad ( 2 )$$

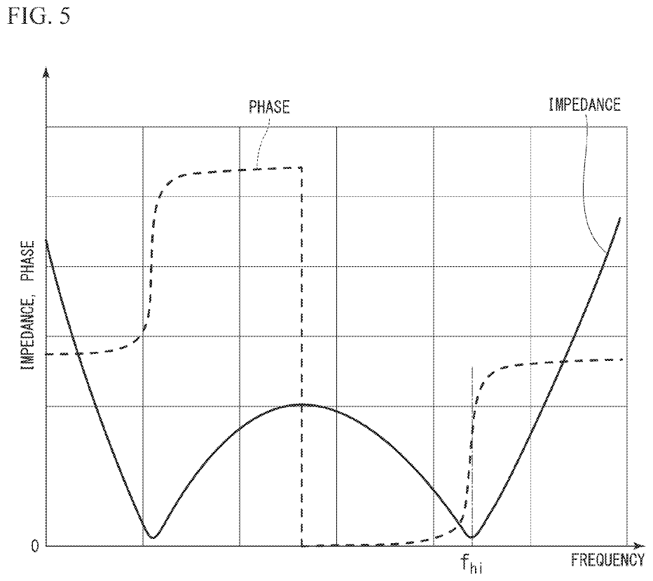

FIG. 5 is a graph view showing an actual measurement example of a correspondence relationship among an impedance, a phase, and a frequency in the coil unit 10 of the embodiment. The impedance and the phase shown in FIG. 5 can be obtained, for example, by measuring the current Ir flowing through the resonance circuit of the electric power reception portion 15 using a shunt resistance having a predetermined resistance value (for example, 1Ω or the like).

As shown in FIG. 5, it can be recognized that at the frequency fₕᵢ of the high frequency mode, the phase difference is zero, and the impedance is locally minimized, that is, the frequency fₕᵢ of the high frequency mode is the resonance point.

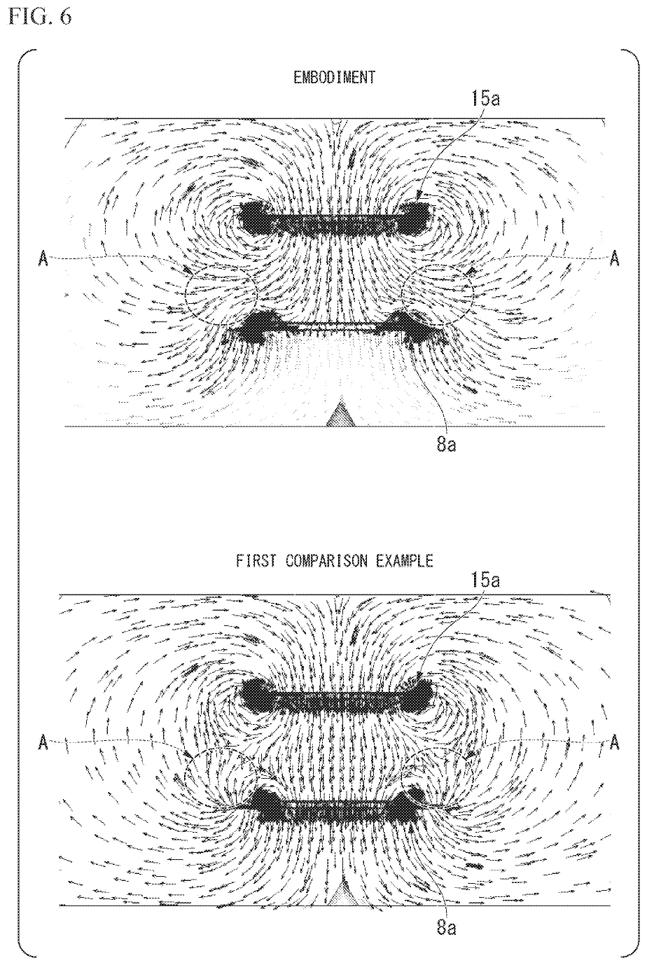

FIG. 6 is a view showing an example of a magnetic flux density distribution (magnetic flux density distribution in a cross-section parallel to a facing direction of the primary side coil 8a and the secondary side coil 15a) in each of the coil unit 10 of the embodiment and a first comparison example. In the coil unit 10 of the embodiment, the capacitance of the secondary side capacitor 15c is set to the capacitance C2 corresponding to the resonance point RPH at the high frequency side. In the first comparison example, the capacitance of the secondary side capacitor 15c is set to a capacitance corresponding to the anti-resonance point ARP.

As shown in FIG. 6, for example, in a neighborhood region A or the like of the primary side coil 8a, in the first comparison example, it can be recognized that a leakage magnetic flux that annihilates a main magnetic flux is generated, and thereby, a magnetic flux transmitted to the secondary side coil 15a is reduced. On the other hand, in the embodiment, it can be recognized that generation of the leakage magnetic flux that interferes with the main magnetic flux is prevented, and thereby, reduction of the magnetic flux transmitted to the secondary side coil 15a is prevented.

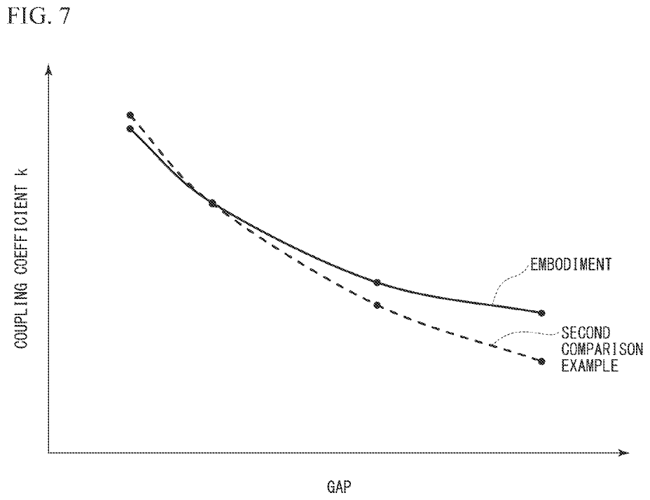

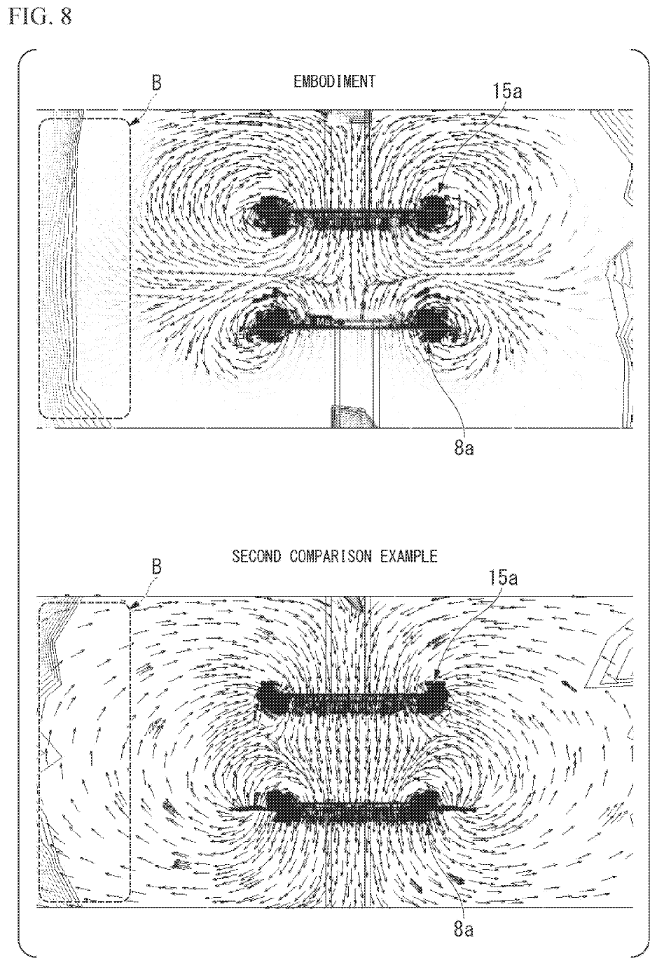

FIG. 7 is a graph view showing an example of a correspondence relationship between a coupling coefficient k and a gap between the primary side coil 8a and the secondary side coil 15a in each of the coil unit 10 of the embodiment and a second comparison example. FIG. 8 is a view showing an example of a magnetic flux density distribution (magnetic flux density distribution in a cross-section parallel to a facing direction of the primary side coil 8a and the secondary side coil 15a) in each of the coil unit 10 of the embodiment and the second comparison example.

In the coil unit 10 of the embodiment, the primary side coil 8a of the electric power transmission device 2 and the secondary side coil 15a of the electric power reception device 4 are provided in a so-called differential type so as to generate a reverse-phase current with each other at the time of electric power transmission. In the second comparison example, the primary side coil 8a of the electric power transmission device 2 and the secondary side coil 15a of the electric power reception device 4 are provided in a so-called cumulative type so as to generate an in-phase current with each other at the time of electric power transmission. In the second comparison example, in a state of looking from a predetermined identical direction such as a facing direction, a wind direction of the secondary side coil 15a of the electric power reception device 4 is set in an identical direction with respect to a wind direction of the primary side coil 8a of the electric power transmission device 2.

As shown in FIG. 7, in the embodiment, it can be recognized that compared to the second comparison example, the decrease of the coupling coefficient k associated with the increase of the gap between the primary side coil 8a and the secondary side coil 15a is prevented.

As shown in Expression (3) described below, the coupling coefficient k between the primary side coil 8a and the secondary side coil 15a is described by a difference between a magnetic field coupling coefficient km and an electric field coupling coefficient kc. In the embodiment, by displacing phases by a magnetic field coupling and an electric field coupling from each other by the differential type, annihilation of the coupling coefficients km, kc is prevented, and reduction of the coupling coefficient k by the electric field coupling is prevented.

$$[ Expression 3 ]$$

$$k = {k}_{m} - {k}_{c} \qquad ( 3 )$$

As shown in FIG. 8, for example, in a peripheral region B or the like of the primary side coil 8a and the secondary side coil 15a, in the second comparison example, it can be recognized that a peripheral magnetic flux density is increased by unwanted radiation. On the other hand, in the embodiment, it can be recognized that the unwanted radiation is reduced, and thereby, the increase of the peripheral magnetic flux density is prevented.

As described above, according to the coil unit 10 of the embodiment, by including the secondary side coil 15a that generates a reverse-phase current with respect to the primary side coil 8a, phases by a magnetic field coupling and an electric field coupling can be displaced from each other, and it is possible to prevent the magnetic field coupling coefficient km and the electric field coupling coefficient kc from annihilating each other. By preventing the coupling coefficient k by the electric field coupling from reducing, it is possible to improve an output density.

For example, compared to the case of including a secondary side coil that generates an in-phase current with respect to the primary side coil 8a, it is possible to prevent the decrease of the coupling coefficient k associated with the increase of the gap between the primary side coil 8a and the secondary side coil 15a, and the coupling coefficient k can be improved. Further, it is possible to prevent the increase of a magnetic flux density around the primary side coil 8a and the secondary side coil 15a due to unwanted radiation.

By setting the wind direction of the secondary side coil 15a of the electric power reception device 4 in an opposite direction with respect to the wind direction of the primary side coil 8a of the electric power transmission device 2 in a state of looking from the predetermined identical direction F, it is possible to easily provide the secondary side coil 15a that generates a reverse-phase current with respect to the primary side coil 8a.

The capacitance of the secondary side capacitor 15c is set to the capacitance C2 corresponding to the resonance point RPH at the high frequency side of the two resonance points RPL, RPH in the frequency characteristic of the impedance Z, and thereby, for example, compared to the case where the capacitance of the secondary side capacitor 15c is set in accordance with the anti-resonance point ARP, it is possible to prevent generation of a leakage magnetic flux that interferes with the main magnetic flux. By preventing the decrease of the coupling coefficient k by the leakage magnetic flux and preventing the decrease of the magnetic flux transmitted to the secondary side coil 15a, the output density can be improved.

By including the control device 17 that sets a frequency corresponding to the resonance point RPH on the high frequency side to the request frequency of electric power transmission by the electric power transmission device 2, the coupling coefficient k can be improved by the increase of the output density and the reduction of the unwanted radiation in the contactless electric power transmission.

### Modification Example

Hereinafter, a modification example of the embodiment is described. The same portions as those of the embodiment described above are denoted by the same reference numerals, and descriptions thereof are omitted or simplified.

The above embodiment is described using an example in which the contactless electric power transmission system 1 includes the storage electric power voltage conversion portion 12 that converts an input/output electric power of the electric power storage device 11; however, the embodiment is not limited thereto. The storage electric power voltage conversion portion 12 may be omitted.

For example, in the case of a hybrid vehicle or the like that is driven using the electric power storage device 11 and an internal combustion engine as a power source, the drive control device 3 may include the storage electric power voltage conversion portion 12, and in the case of an electric automobile or the like that is driven using the electric power storage device 11 as a power source, the drive control device 3 may not include the storage electric power voltage conversion portion 12.

The embodiments of the present invention have been presented as examples and are not intended to limit the scope of the invention. These embodiments can be implemented in a variety of other modes, and various omissions, substitutions, and modifications can be made without departing from the scope of the invention. These embodiments and modifications thereof are included in the scope and gist of the invention and are also included in the scope of the invention described in the appended claims and equivalent thereof.

What is claimed is:

1. A coil unit comprising:
a coil that generates, when receiving an AC electric power transmitted in a contactless manner from an electric power transmission-side coil of an electric power transmission device, a reverse-phase current with respect to the electric power transmission-side coil.

2. The coil unit according to claim 1,
wherein in a state of looking from a predetermined identical direction, a wind direction of the coil is set in an opposite direction with respect to a wind direction of the electric power transmission-side coil.

3. The coil unit according to claim 1, comprising:
a resonant capacitor connected in series to the coil,
wherein a capacitance of the capacitor is set in accordance with a resonance point on a high frequency side of two resonance points in accordance with the coil and the capacitor.

4. The coil unit according to claim 3, comprising:
a control device that sets a frequency corresponding to the resonance point on the high frequency side to a request frequency of electric power transmission by the electric power transmission device.

5. The coil unit according to claim 2, comprising:
a resonant capacitor connected in series to the coil,
wherein a capacitance of the capacitor is set in accordance with a resonance point on a high frequency side of two resonance points in accordance with the coil and the capacitor.

6. The coil unit according to claim 5, comprising:
a control device that sets a frequency corresponding to the resonance point on the high frequency side to a request frequency of electric power transmission by the electric power transmission device.
